(19) United States
(12) Patent Application Publication
(10) Pub. No.: US 2014/0379402 A1
(43) Pub. Date: Dec. 25, 2014

(54) TrekLink

(71) Applicant: Robert T. DeSalle, JR., Wallingford, CT (US)

(72) Inventor: Robert T. DeSalle, JR., Wallingford, CT (US)

(21) Appl. No.: 14/311,149

(22) Filed: Jun. 20, 2014

Related U.S. Application Data
(60) Provisional application No. 61/837,548, filed on Jun. 20, 2013.

(51) Int. Cl. G06Q 50/14; G06Q 50/00; G06Q 10/10

(52) U.S. Cl. CPC G06Q 50/14; G06Q 10/1093; G06Q 50/01
USPC 705/7.18

(57) ABSTRACT

A method helps people sharing common passions or interests to collaborate and experience a Trek together. This method is able to be run on a website or in application software for a handheld device. It first asks a user to set up an account, which is one of a few different levels of accounts and a type of account can be converted to another type of account. A user can set up a calendar for a future Trek. Moreover, this method can conduct a search for a Trek or a potential companion, as well as facilitate communication between Trek matches. After a Trek has been made, one can share a Trek experience and review the Trek and his or her companion. Furthermore, this method is able to provide customized advertisements or to be integrated with a travel agency or social media.

The current application claims a priority to the U.S. Provisional Patent Application Ser. No. 61/837,548, filed on Jun. 20, 2013.

### FIELD OF THE INVENTION

The present invention relates generally to travel planning social and communication system. More specifically, the present invention is a system that allows a single user or multiple users or groups of common traveling interests to plan, communicate and collaborate in order to experience activities together.

### BACKGROUND OF THE INVENTION

It has been increasingly popular among travelers to actively explore and experience their destinations and enjoy it with a group of other people who share the same hobby or interest. Travelers often seek to establish connections with both locals and other travelers/vacationers. Additionally, travelers often seek to immerse themselves in the respective environments of local attractions such as sporting events, historical sites, and nature expeditions.

An often encountered issue when traveling for business or pleasure is the misalignment of schedules between travelers and their friends, significant others, and/or relatives. This often makes it difficult to experience activities or events with one companion or a group, even more so if the companion does not share the same passions or interests as those of the traveler. The problem is exacerbated by the exorbitant costs of partaking in activities or events as a solo participant. Furthermore, it is simply not exciting or enjoyable to experience some attractions alone. The present invention seeks to address the aforementioned issues and provides an approach of connecting people of similar interests so as to experience activities together.

The present invention is a system that allows solo users and groups of users sharing similar interests to interact and collaborate. One objective of the present invention is to promote communal participation in shared passions by focusing on user interests, user geographical location, and user availability or time schedule.

With bringing together different users that share common interests, the invention promotes communal participation as well as networking in shared interests. This allows individual users or groups of users of the similar interests to participate together and thus results in benefits such as shared and or discounted expenses, companionship, and the opportunity to build and strengthen relationships. The present invention may also be integrated with social media networks and online dating networks. Furthermore, the present invention may work in conjunction with travel agencies in order to facilitate Trek planning for users.

### BRIEF DESCRIPTION OF THE DRAWINGS

FIG. 1 is a flowchart showing various types of accounts being set up in the present invention.

FIG. 2 illustrates the setting up of a calendar, the WishTrek.

FIG. 3 illustrates the process of searching for a match in the present invention.

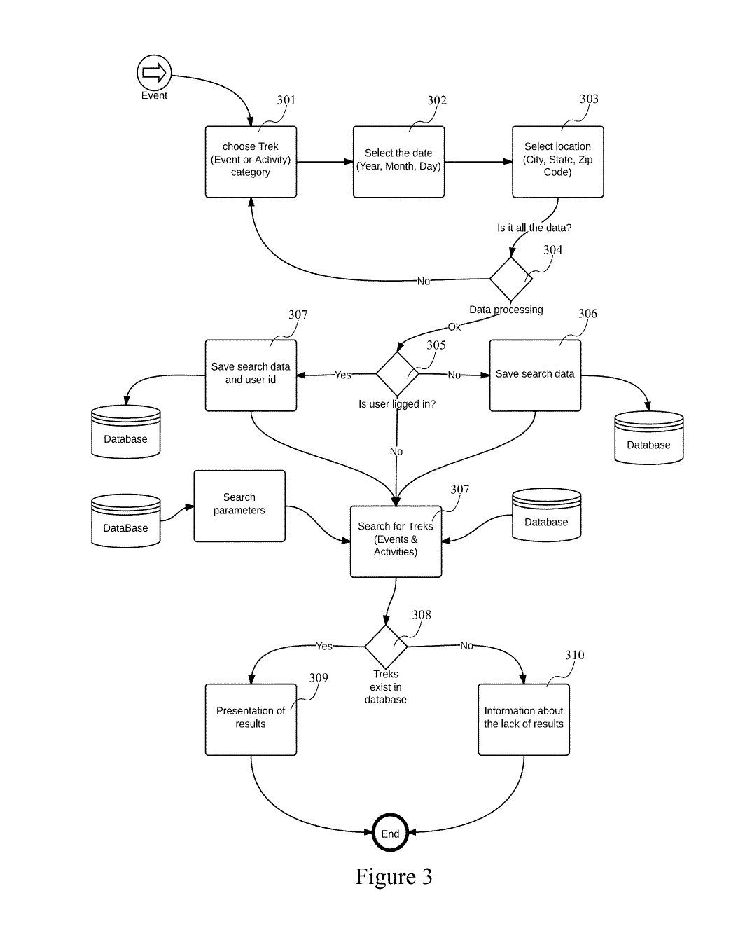

FIG. 4 is an illustration of the CorkBoard of the present invention.

FIG. 5 is a flowchart showing the process of posting Trek photos.

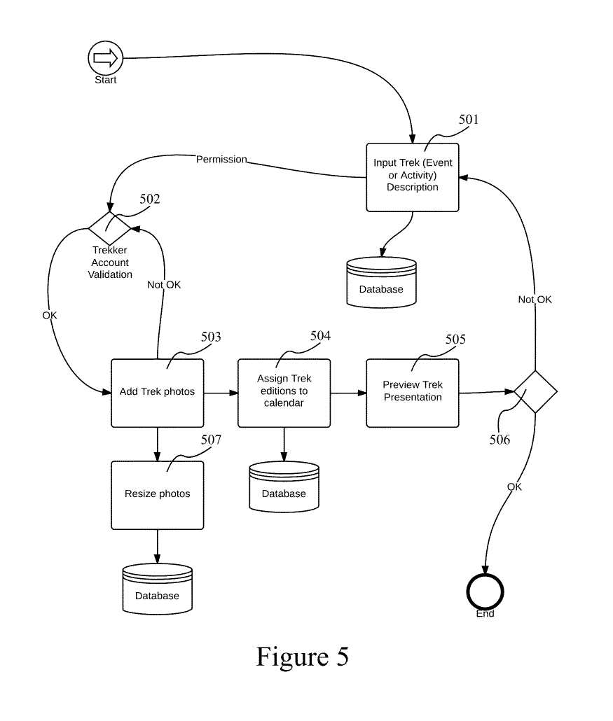

FIG. 6 shows a companion rating form.

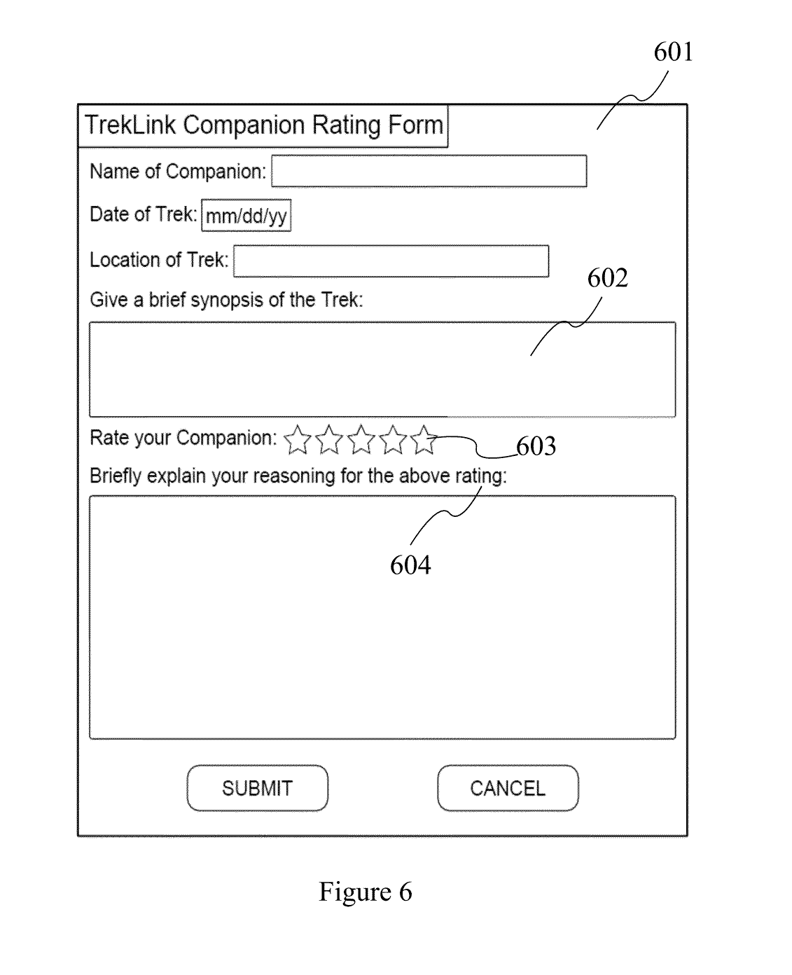

FIG. 7 shows an advertisement page, which is a part of the CorkBoard.

FIG. 8 is an illustration of the front page of the Corkboard.

FIG. 9 is a demonstration of the function of Trekker Matches (TM) the CorkBoard.

FIG. 10 is a demonstration of the fuctiion of Friends the CorkBoard.

FIG. 11 is a demonstration of the function of the Notifications of the CorkBoard.

### DETAILED DESCRIPTIONS OF THE INVENTION

All illustrations of the drawings are for the purpose of describing selected versions of the present invention and are not intended to limit the scope of the present invention.

The present invention is a system for bringing together and allowing users of shared interests to interact and collaborate with the intent of experiencing activities, events, trips, and/or attractions (henceforth referred to as “TTreks”) together. Treks vary in terms of scope and range from single day/single activity weekend Treks to long-term international Treks. The system is centered on a website and mobile (or other handheld device) application through which users may interact. The system is integrated with existing social media networks, online dating networks, and travel agencies in order to serve as a portal for personal networking and Trek planning.

An overall representation of the TrekLink system mainly comprises 3 major sections: 1) the management section, 2) the communication section and 3) the social interaction section. More specifically, the management section further comprises a TrekLink calendar, an immediate TrekLink and WishTrip or Trekwish. The communication section further comprises the anonymous communication, private communication, and the Trek board communication. Furthermore, the section of social interaction comprises a user's personal profile, real time alerts of Trek matches, integration with outside social media, user reputation and Trek share system, which may comprise a photo gallery and blog system.

Users are required to create different types of accounts with personal profiles and provide information about themselves including, but not limited to, personal interests, past travels/endeavors, certifications, and accomplishments. These personal profiles are used to organize users into demographics based upon interests shared by all members of that demographic. The users are able to share information regarding Trekstreks that they wish to experience as well as dates and time periods during which the users are available.

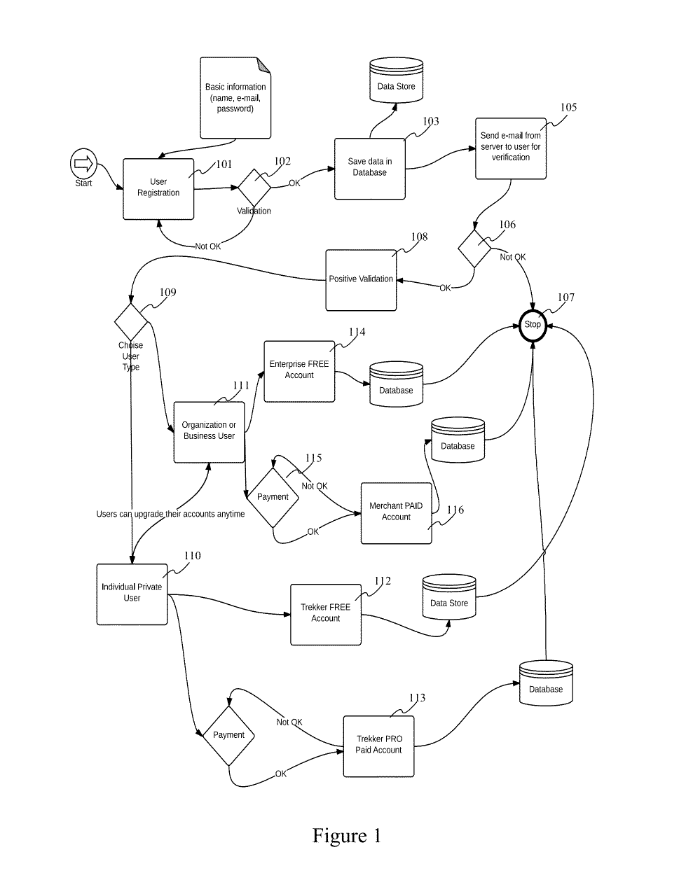

The user is required to create a personal profile and provide information such as personal interests, past travels/endeavors, certifications, and accomplishments. As shown in FIG. 1, a user would first be required to do the registration 101. During registration, a user will be asked to provide basic personal information, such as user name, password, email address, etc. After that, the system will check if such information is valid 102. For example, if an email address does not contain the @ character, then it would be deemed invalid. Once the information is validated, the data will be saved in a database 103, and a confirmation email will be sent to the user 105. If it has not been confirmed by a user 106, then it will be terminated 107. On the other hand, after receiving a confirmation from the user 108, the user will be led to choose between various types of accounts 109, including an individual account 110 and a business user account 111. The key difference between an individual account and a business account is that a business is promoting its business service and would charge a fee or a price for the service. On the other hand, an individual is one looking for a partner to participate in an activity or make a travel arrangement together, and he or she does not charge a price or any other fee. In addition, the individual account can be further separated into two types of accounts, the Trekker Free account 112 and the Trekker Pro account 113. Similarly, the business account could also be divided into two types of accounts, namely, the Merchant PAID account 116 and the Enterprise FREE account 114.

A user may adjust the privacy settings of his or her personal profile as desired. Additionally, if the user wishes, he or she may associate the new personal profile with any existing social media network, online dating network, or other similar network. The TrekLink system provides an integration interface in which all brands, services, networks, etc. that the TrekLink system may be integrated with are listed. The user is able to use this list to select and deselect the services with which the personal profile is to be interfaced. As is the case with similar social media networks and online dating networks, unregistered visitors may not view all personal information included in a profile.

Unregistered users and non-members (Guests) may browse selected information. However, the unregistered users and non-members may not interact with TrekLink users or with the TrekLink system. The information of the personal profile is used to sort the user into a specific demographic containing other users of closely related characteristics that are provided in their personal profiles.

In the present invention, different accounts would have different privileges to use the resources and services of the present application. A guest is a person who wants to use the TrekLink Website and Apps, but doesn't want to share contact information and/or create a Personal Account. A guest can browse the entire TrekLink Website and Apps but will have no access to: A). An Account—where other active users can create, publish and manage their own Profile when they are logged in, B). The Treks (Events and Activities) Calendar—where other active users can create, publish and manage Treks. C). The CorkBoard—a platform where other active users connect and collaborate with each other. D). Treks discounts—exclusive offers for active Trekker and Trekker PRO users.

A Trekker is a person who wants to use the TrekLink Website and Apps and is willing to share basic contact information and create a Personal Account, but does not wish to pay an entry fee. A Trekker can browse the entire TrekLink Website and Apps. Their account allows them the following access: A). Profile—A Trekker can create, publish and manage their own Profile. B). The Treks (Events and Activities) Calendar—A Trekker can create Treks, but CAN NOT publish and manage them like the Trekker Pro users. C). The CorkBoard—A Trekker can access the platform where other active users connect and collaborate with each other. D). Trek discounts—A Trekker CAN NOT access exclusive offers available to users with active Trekker PRO accounts.

Trekker PRO is a paid account for individuals or groups who want to use the TrekLink Website and Apps to browse and create their own Treks (Events and Activities). We offer monthly, quarterly or yearly rate options for Trekker PROs. A Trekker PRO can browse the entire TrekLink Website and Apps. A). Profile—A Trekker PRO can create, publish and manage their own Profile. B). The Treks (Events and Activities) Calendar—A Trekker Pro can create, publish and manage Treks, but can only post free events. A Trekker PRO CAN NOT charge any fees to other users for participation in their Treks. C). The CorkBoard—A Trekker Pro can access the platform where other active users connect and collaborate with each other. D). Trek discounts—A Trekker PRO can access all special offers and discounted prices.

Trekker Enterprise is a free account prepared for businesses and organizations interested in advertising/posting Treks (Events and Activities) on the TrekLink Website and Apps, but not willing to pay any fees. This type of account is also used as a trial account. The business or organization must designate an administrator to open an administrator account in order to setup, publish and manage a Trekker Enterprise Profile and Trekker Enterprise Account. The Treks Calendar—Trekker Enterprise administrators can create Treks, but cannot publish and manage them like active TrekLink Merchants. The CorkBoard—Trekker Enterprise administrators cannot access the platform where other active users post questions and booking requests.

A Trekker Merchant is a paid account prepared for businesses and organizations interested in advertising/posting Treks on the TrekLink Website and Apps. It is offered with monthly, quarterly or yearly rate options for Trekker Merchants. A). The Account—The business or organization must designate an administrator to open an Administrator Account in order to setup, publish and manage a Trekker Merchant Profile and Trekker Merchant Account. B). The Treks Calendar—A Trekker Merchant Administrator can create, publish and manage unlimited Treks. B). The CorkBoard—The Trekker Merchant Administrator has access to the CorkBoard platform where other active Trekkers can post questions, comments and booking requests.

In addition, Trekker Merchant accounts with past due payments will revert to Trekker Enterprise accounts. A Trekker PRO with past due payments will revert to a basic Trekker.

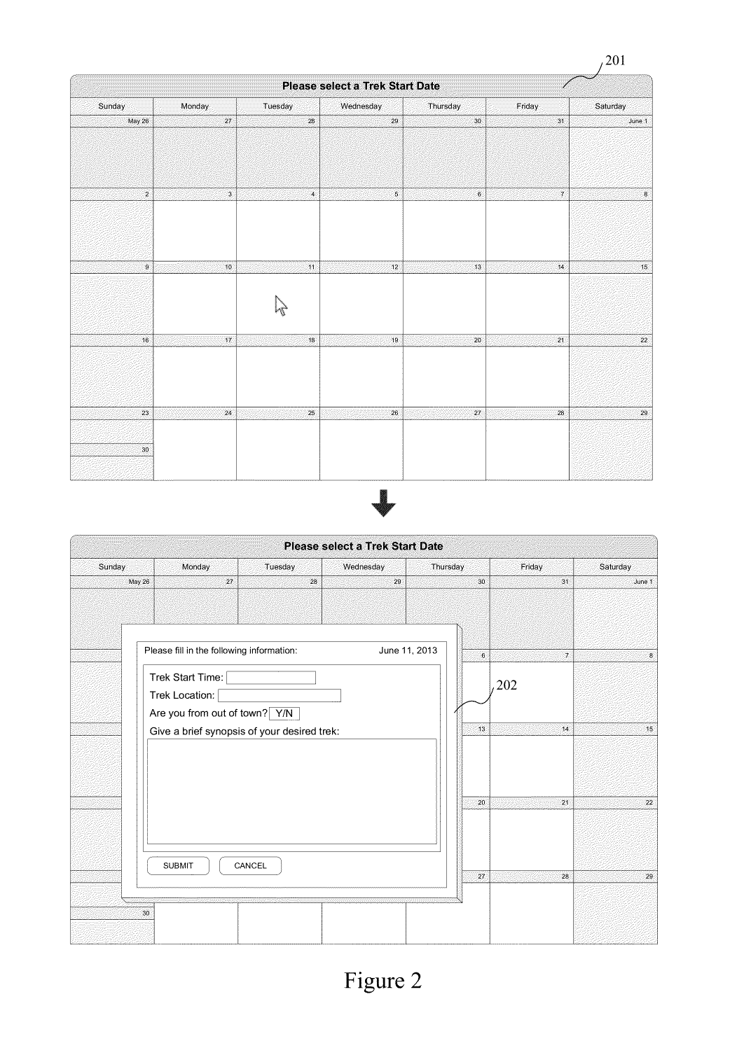

In reference to FIG. 2, After registration and account set up, a user then would be able to set up a personal calendar 201 by providing information relating to his or her desired Treks (“WishTrip”/“TrekWish”). This information is supplemented with information regarding availability in terms of date, time, location, and whether or not the user is from out of town, etc. The calendar interface displays a monthly calendar for the user to click a desired Trek date. Once a date has been chosen, a Trek information form 202 is displayed to the user. The user is directed to input information relating to the time, location, and synopsis of the Trek. The user is also able to indicate whether he or she is from out of town. Here are examples of 1 possible Trek opportunities:

A user has a spare ticket to a sporting event, musical show, or educational seminar and would like to share with a companion.

A user is in the area on business travel and would like a companion to join them around the area for the duration of the business trip (potentially someone else not native to the area who is on business as well).

A couple on vacation seeks other couples to join them in deep-sea fishing, scuba diving, or mountain climbing and the like.

A user whose significant other does not share the same enthusiasm for a particular activity would still like to experience that activity one day.

A displaced sports fan has moved recently to a new area and seeks other displaced or local sports fans of the same team to go to a sporting event featuring his or her favorite team.

Of course, the activities are not limited to the aforementioned examples. As can be seen, Trek information may take on virtually any form. A user can always find new creative ways to use the services of the present invention.

The Trek request information is posted to a system discussion board that is categorized based on the user's interests and demographics. The Trek request information is used to draw matches from among the other users of the user's demographic. The user is provided Trek, date, time, and location information regarding potential matches found from among the other users. Users that have opted for notification of matches are notified by the system. Additionally, users are able to receive immediate notifications for new, local Trek opportunities through the “TrekNow” feature. TrekNow utilizes geological tracking to determine if users wish to trek within a 0-24 hour time period. After a search has been initiated by a user, the user will first be asked to choose a search category, event or activity 301. Then, the user needs to select the date (year, month and day) 302 when the Trek will be performed. Next, a location 303 of the selected events or activities will be requested. Next, a question about other available information will be asked. 304. Next, the data will be processed if there is no new information. After that, is will be determined if the user has logged in 305. If the user has been logged in, then both data and user ID will be saved 307 in a database. On the other hand, if no log in takes place, then just the search data will be saved 308 in the database.

Subsequently, a search 307 would be performed for the Trek. The search may be performed directly from the database or from a database through a parameter search. The search results will determine if the Trek information exists in the database 308. If yes, then 309 the search result of the Trek information will be presented. Otherwise, the user will receive a notice about the lack of results 310.

Upon receiving information regarding potential matches, the user is able to communicate anonymously with the matches. This allows all users to gain a level of comfort before proceeding in the process. Users that wish to collaborate further with the potential matches are then able to exchange personal contact information for further networking and Trek planning.

Further, the present invention collects stores and analyzes data from all users and all kinds of activities that take place on the TrekLink Website and Apps. When a TrekLink User creates an account, a record of all information about the Trekker that is provided during account setup, like: username, email address and password will be stored. From Trekker, Trekker PRO, Trekker Enterprise and Trekker Merchant User's Profiles, all information entered will be saved, such as first, middle and last name, home address with state and zip code, phone number, ethnicity, gender, income, languages, pictures, biography, business type and more. Specialized information is also saved, like experience level and a Trekker's favorite location and time preferences as documented on that individual's profile, as well as links to a Trekker's or Trekker Merchant's social networks, YouTube videos and more. From browsing history of related information, the present invention captures each browsing entry made on the TrekLink Website and Apps by all TrekLink account holders and Guest Users. Additionally, the invention keeps a record of the selected Category, Location and Day of every occasion when a Trekker or Guest User engages the Browse button. The invention also saves/records all Treks that are accessed by Trekkers and any event entries that are exposed when Trekkers or a Guest User engages the “See details” prompt to access more information about specific Treks. It also accumulates and saves all information posted on TrekLink's CorkBoard, including any messages, comments, and questions, booking information posted by a Trekker to another member or a Trekker Merchant's CorkBoard. When any Treks or Treks with specific times and locations are created by Trek Link account holders, the invention would access and save all information entered. When a Trekker or Trekker PRO posts reviews and offers feedback on Treks that were organized by a Trekker PRO or a Trekker Merchant, that information is accumulated and saved. When Trekker PRO or Trekker Merchant makes a payment, the invention keeps a record of all payment transactions. Trekker Enterprise and Trekker Merchants that are IMS Barter members will provide an IMS Barter Account number and email assigned to IMS Barter Account that will be recorded and saved.

The invention keeps a record of the selected Category, Location and Day of every occasion when a TrekLink member or Guest User engages the Browse button. The invention also saves/records all Treks that are accessed by users and any additional information that is exposed when a user engages the “See details” prompt to access more information about specific Treks. A record of Trekkers' general account and profile information is used to compare and match them with information provided by other users. The invention keeps records of a Trekker's browsing history and uses this information to connect Trekkers to the same category, location and time of Treks they are looking for. The CorkBoard database is stored in separate folders with many filters that narrow the results: Messages from other logged Trekkers. Events matching to categories that are based on experience level, location and time frame selected in the Trekker's profile. Contacts and links to profiles of other Trekkers who have searched for the same Treks in the past (same category, location and time frame). The invention keeps record of all bookings made by Trekker PRO and Trekker Merchants. Trekker Merchant Administrators can also add price (per person) for each Trek as well as price description. The invention collects specific information about Treks created by Trekkers, including title, short description, details, category, subcategory, experience level, address, state, location, limit of participants, quantity available (seats), picture gallery, YouTube videos, link to Google maps and more. A Merchant Administrator can publish Treks by creating Treks Edition(s) in the calendar. Payment information is recorded and organized by date that payment is received. The invention keeps separate folders for Trekker Merchants for all payments made.

Data is organized by the most popular to the least popular category, location, days and Treks. The invention also separates Treks Editions (activities that occur at specific times during the day). All of that information is available to the TrekLink Management Team on a password protected website.

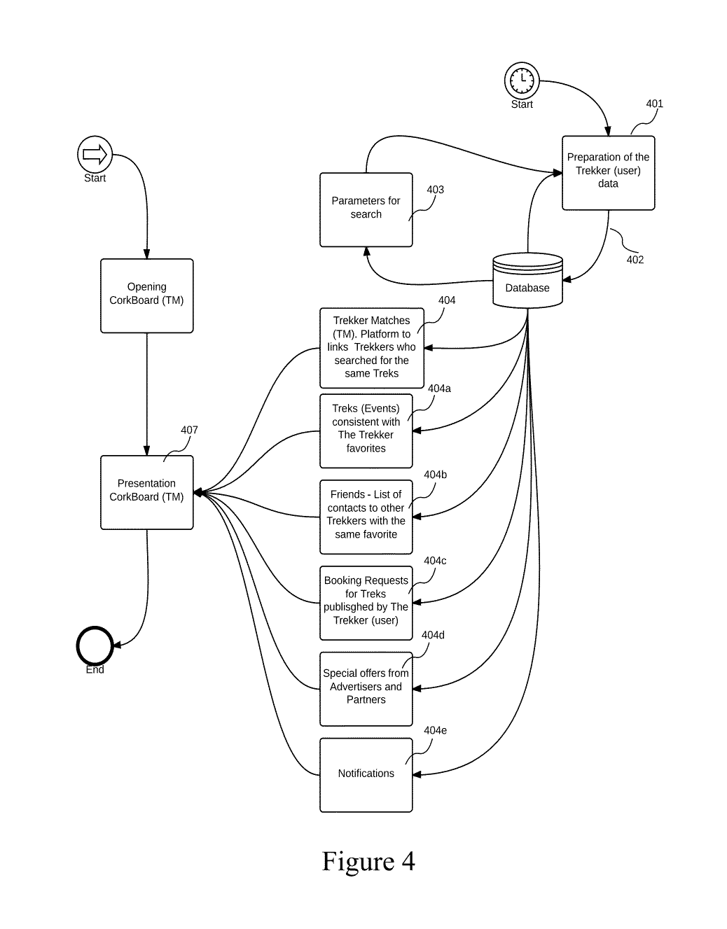

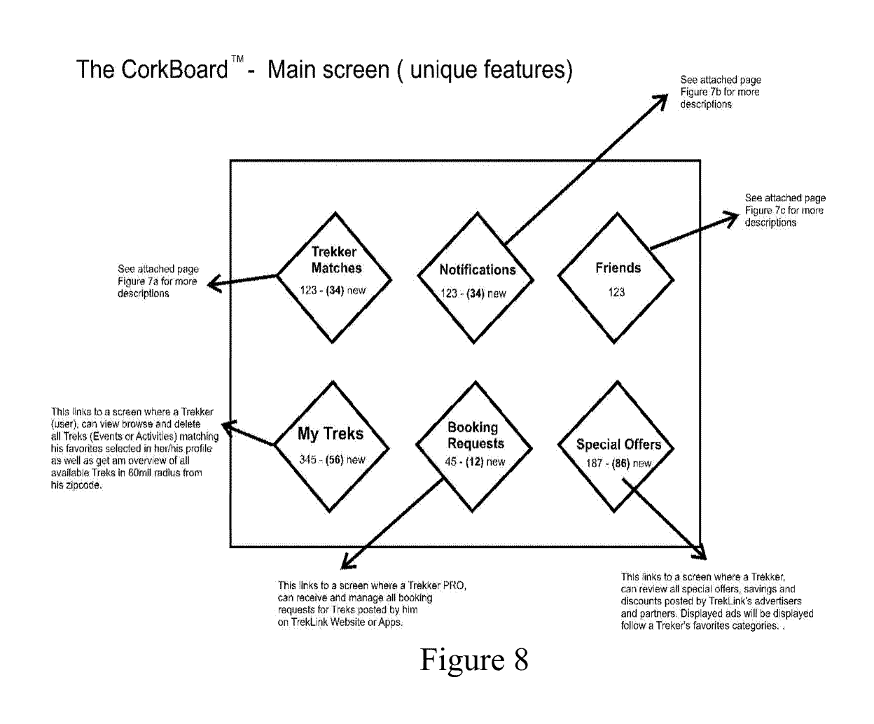

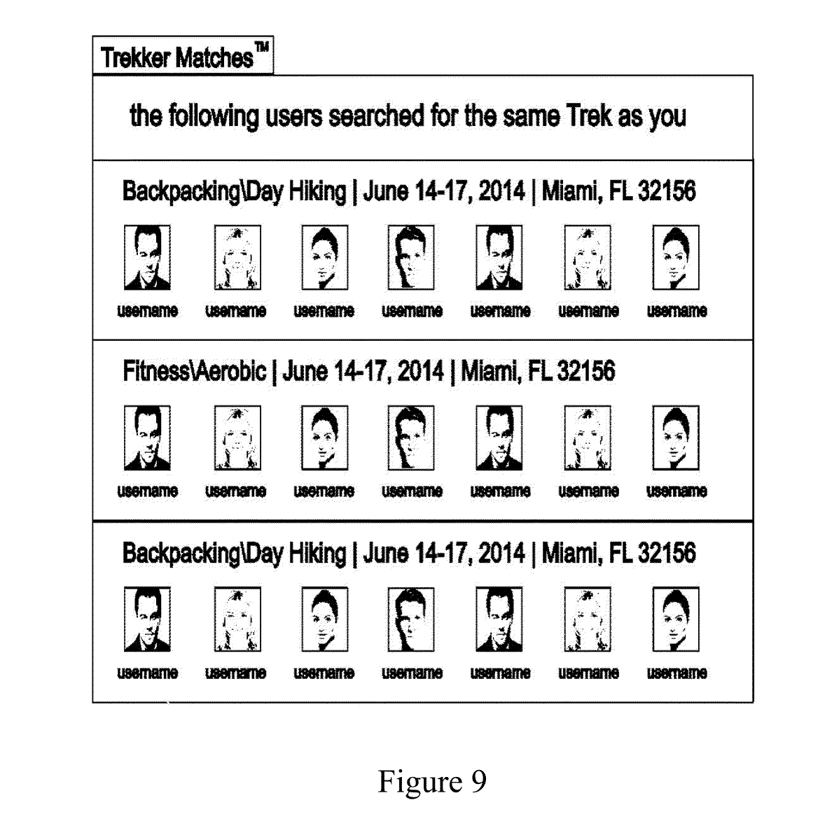

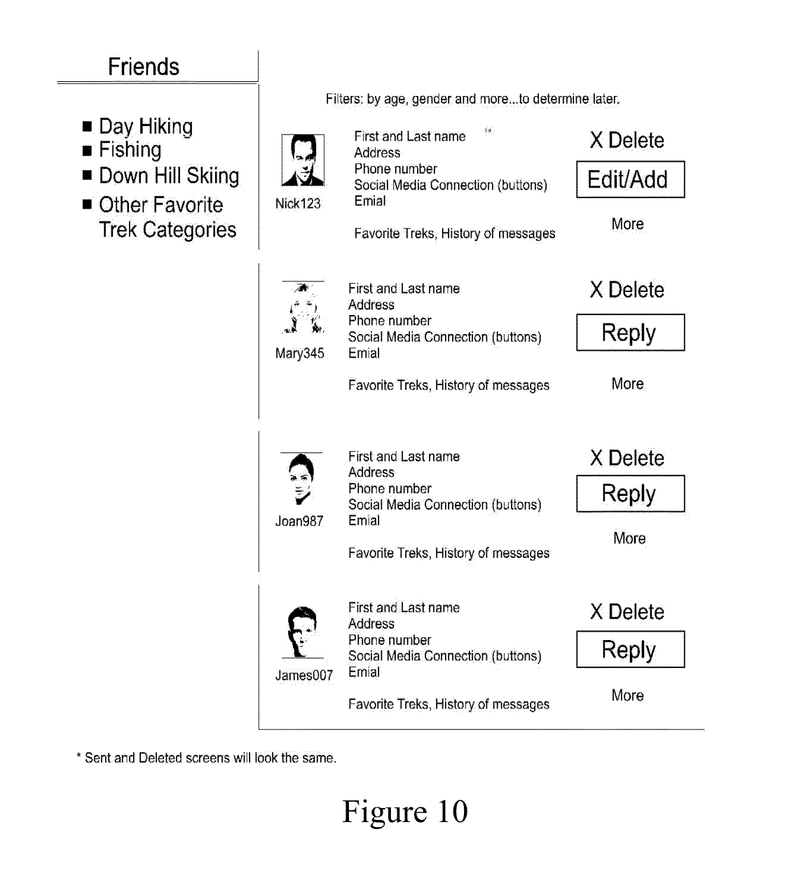

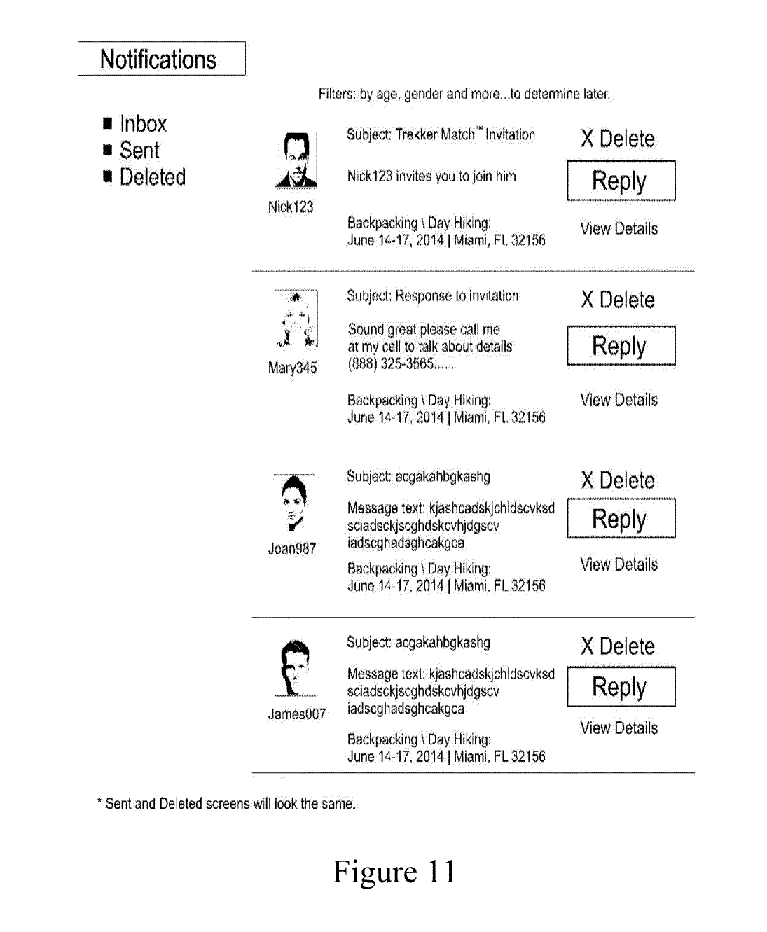

As mentioned previously, the CorkBoard is a platform and key part of the present invention, where other active users connect and collaborate with each other. The user data will first be prepared 401 and then saved 402 to the database. As shown in FIG. 4, the CorkBoard comprises a number of critical functions of the present invention. Trekker Matches (TM) 404 links to Trekkers' profiles who asked for the same Treks using TrekLink's search on the front page (FIG. 8). TrekLink (TM) offers standard and easy to use templates of the messages, such as Invitation, Respond, Not interested, Change my plans and the like. In reference to FIGS. 8 and 9, when Trekker (user) click on the picture can view the profile of the other Trekker (user) and can connect with her/him by sending a standardized message or remove through the Corkboard. My Treks 404a, as a standard feature connected to the CorkBoard TM, it links to a screen where a Trekker (user), can view browse and delete all Treks (Events or Activities) matching his favorites selected in her/his profile as well as get an overview of all available Treks in 60 miles of radius from his Zip Code. In reference to FIG. 8 and FIG. 10, via the Friends function 404b (Friends) Trekkers can save and manage all their contacts history with other Trekkers. The Booking Request 404c, a standard feature connected to the CorkBoard TM, it links to a screen where a Trekker PRO, can receive and manage all booking requests for Treks posted by him on TrekLink TM Website or Apps. In addition, the Special Offers 404d, as another standard feature connected to the CorkBoard TM, it links to a screen where a Trekker, can review all special offers, savings and discounts posted by TrekLink's advertisers and partners. Displayed ads will be displayed following a Treker's favorites categories (please refer to FIGS. 4, 7 and 8). Moreover, in reference to FIG. 11, the CorkBoard also includes a function of Notification 404e. It displays notifications from other Trekkers who asked for the same Treks using TrekLink's search on the front page and decided to connect with Trekkers selected from Trekker Matches TM.

Following a completed Trek, users may share their experiences with others through a photo gallery and/or blog system. Users sharing their experiences may regulate privacy settings on their posted entries as needed. Furthermore, the system of the present invention allows users to provide feedback on their Trek companions. This allows future users to quickly assess whether a potential companion is reputable and trustworthy during the networking process. Accumulating ratings from companions allows a user to develop a reputation over time and facilitate development of comfort with potential matches in the future. Additionally, a user's Trek history is stored in his or her personal profile. The Trek history may be organized based on date, location, and Trek information. Furthermore, the user may input future desired Treks that he or she wishes to experience but for which concrete plans are not yet developed.

The present invention also provides further opportunities for users to interact. Users are able to share their Trek experiences with others through posting a photo or phone gallery and/or a blog. Interaction is promoted by allowing users to make comments, tags and the like. A user will be first prompted to input the description of the Trek he or she just participated in or enjoyed 501. The information entered by the user will be saved in the database. Next, the present invention will conduct an account validation 502. After being validated, one or a plurality of Trek photos will be promoted to be uploaded 503. The uploaded pictures will be resized 507 in order to be posted. A Trek Edition is next to be assigned to calendar 504. The finished Trek presentation is next previewed 505 before being posted and finally, it is posted. If it does not pass the review 506, the user will be promoted back to the beginning to either restart or make further edits.

The present invention also includes a reputation system wherein users are able to positively or negatively review or rate their companion(s) following a completed Trek. In addition to a user's historical reputation, his or her Trek history is also stored with the personal profile. In the event that a user has a Trek that he or she wishes to experience, but has no concrete plans set in place, the future Trek may be entered into the Trek history as well. In order to make a review for a Trek companion, a user needs to fill out the companion rating form 601. In addition to filling out the companion's name, and date and location of the Trek, the user is also required to provide a brief synopsis of the Trek 602. Then, the user needs to rate the companion from a predetermined range 603, such as from 1 to 5. Subsequently, the user may also be asked to provide the reason 604 for such a rating.

The process described above provides the basis for interaction between system users. This allows users to communicate further to determine relevant Trek details such as meeting time, meeting location, housing accommodation/cost, Trek duration, and Trek itinerary. This process may be aided through the integration of the system with traditional travel agencies. Although the present invention is primarily centered on the website and mobile application platforms, the present invention may be extended to other platforms as well. The present invention is capable of integration with the following: travel services (airlines, hotels, car rental services), destination services (resorts, lodges), arts and entertainment services, sporting events/teams, retailers catering to specific markets/demographics (sports gear, vehicle manufacturers, outfitters) brands catering to specific markets/demographics (sports networks, cinemas), travel agencies, and discount providers.

The TrekLink system may be integrated with the above sources, brands, and outlets through a subscription system. For example, travel service websites may install a TrekLink module to directly connect travelers using both the travel service websites as well as TrekLink. This allows travel service companies to increase overall sales and revenue. Additionally, TrekLink users are able to opt in and opt out of offers provided by the above listed sources, brands, and outlets. These offers may be tailored specifically to the users in terms of interests and timeframes of desired and future Treks. In this manner, TrekLink is able to allow retailers/suppliers to connect with customers. Retailers/suppliers may be rated by customers and once the rating has reached a consistently high level, the retailers/suppliers are recommended by the TrekLink system. TrekLink users are able to quickly select single (Trekking alone), one companion (Trekking as a pair), group up to five, and group larger than five. This allows retailers/suppliers to conveniently determine product quantities required for individual Treks.

Although the primary intended use for TrekLink is to allow Trekkers to come together and collaborate, TrekLink has applications in other fields relating to advertisers and service providers that are integrated with TrekLink. For example, a fishing boat captain may utilize TrekLink in order to fill spots on the fishing boat prior to setting sail.

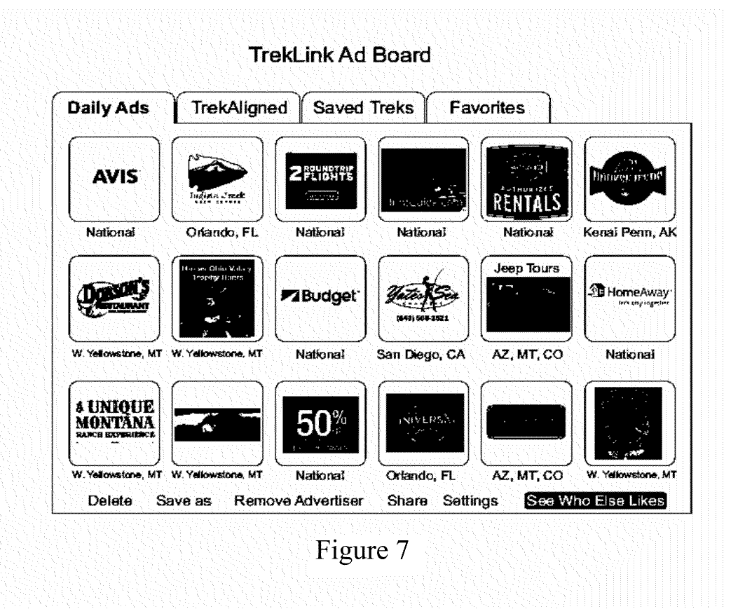

The TrekLink system may include an advertisement board which caters to a user in terms of interest and past experiences, as shown in FIG. 7. The TrekLink system includes daily advertisements, Trek-aligned advertisements, saved Treks, and favorites though the TrekLink advertisement board and is not limited to these specific advertisement options. The TrekLink system daily advertisements (henceforth referred to as Dailies) are customized by members. Members may customize the type of advertisements, frequency of those advertisements, and limit the amount of advertisements shown on a daily basis. As advertisement offers expire, new advertisements stream in automatically within the Dailies. This keeps the content fresh and increases impulsive shopping and purchasing. TrekLink consists of “Trek-Aligned” advertisements which are considered, purchased, or committed to by a member. These advertisements are immediately aligned with a specific Trek for future reference, access, and itinerary building. “Saved Treks” within the TrekLink system are accessible universally throughout the TrekLink website. The user is able to review details of past Treks, vendors, suppliers, photographs, reviews, shops, travel accommodations, etc. Finally, a “Favorites” section of the advertisement board allows members the option to access all of their favorite elements from past Treks. In addition, a tab for “Avoid at all Costs” may be included. This tab is for things and places TrekLink members may wish to avoid next time out.

Although the present invention has been explained in relation to its preferred embodiment, it is understood that many other possible modifications and variations can be made without departing from the spirit and scope of the present invention.

What is claimed is:

1. A non-transitory computer-readable medium that stores instructions executable by one or more processors to perform a method for people sharing common passion or interests to collaborate and experience a Trek together, comprising
instructions for establishing an account;
instructions for setting up a calendar;
instructions for executing a search for a Trek, wherein said Trek comprises an activity, event, trip and attraction;
instructions for facilitating communication among users;
instructions for sharing a Trek experience; and
instructions for reviewing a finished Trek.

2. The non-transitory computer-readable medium that stores instructions executable by one or more processors to perform a method for people sharing common passion or interests to collaborate and experience a Trek together as claimed in claim 1, said instructions for establishing an account comprising:
instructions for promoting a user to register;
instructions for receiving personal information, wherein said personal information comprises user name, password, email address and demographic date;
instructions for receiving a personal profile, wherein said personal profile comprises personal interest, travel experience, certification and accomplishment;
instructions for checking if said personal information is valid;
instructions for saving said personal information and said personal profile in a database;
instructions for sending a confirmation email to said user; and
instructions for promoting said user to select an account type, wherein said account type comprises guest account, Trekker account, Trekker PRO account, Trekker Enterprise account and Trekker Merchant account.

3. The non-transitory computer-readable medium that stores instructions executable by one or more processors to perform a method for people sharing common passion or interests to collaborate and experience a Trek together as claimed in claim 2, further comprising
instructions for designating said guest account to an individual who wants to use said method for people sharing common passion or interests to collaborate and experience a Trek together, but does not want to share information;
instructions for designating said Trekker account to an individual who wants to use said method for people sharing common passion or interests to collaborate and wants to share information, but does not want to pay a fee;
instructions for designating said Trekker account to an individual who wants to use said method for people sharing common passion or interests to collaborate, wants to share information, and wants to pay a fee;
instructions for designating said Trekker Enterprise account to a business that does not want to pay a fee; and
instructions for designating said Trekker Merchant account to a business that wants to pay a fee.

4. The non-transitory computer-readable medium that stores instructions executable by one or more processors to perform a method for people sharing common passion or interests to collaborate and experience a Trek together as claimed in claim 1, said instructions for setting up an account comprising:
instructions for displaying a blank calendar;
instructions for clicking on an expected date for a desired Trek;
instructions for providing information of said desired Trek, wherein said information of a desired Trek comprises expected location and expected activity; and
instructions for saving said information of said desired Trek in a database.

5. The non-transitory computer-readable medium that stores instructions executable by one or more processors to perform a method for people sharing common passion or interests to collaborate and experience a Trek together as claimed in claim 1, said instructions for executing a search for a Trek comprising:
instructions for selecting a category for a searched Trek;
instructions for selecting a date for said searched Trek;
instructions for selecting a location for said searched Trek;
instructions for processing information for said searched Trek;
instructions for saving said information for said searched Trek in a database;
instructions for searching for said searched Trek; wherein said searching comprises a parameter searching; and
instructions for presenting a search result, wherein said search result is a match of said searched Trek or no information found.

6. The non-transitory computer-readable medium that stores instructions executable by one or more processors to perform a method for people sharing common passion or interests to collaborate and experience a Trek together as claimed in claim 1, said instructions for facilitating communication among users comprising:
instructions for informing a first user who initiates said search for said Trek after a match is found;
instructions for informing a second user who is found as a match of said search;
instructions for executing an anonymous communication between said first user and said second user; and
instructions for facilitating further communication between said first user and said second user.

7. The non-transitory computer-readable medium that stores instructions executable by one or more processors to perform a method for people sharing common passion or interests to collaborate and experience a Trek together as claimed in claim 1, said instructions for sharing a Trek experience comprising:
instructions for providing information of said Trek experience, wherein said Trek experience comprises date, location and activity;
instructions for uploading a photo or a plurality of photos in said Trek experience;
instructions for resizing said photo or a plurality of photos being uploaded;
instructions for presenting a preview of said photo or a plurality of photos for approval;
instructions for displaying an approved photo; and
instructions for displaying said information of said Trek experience.

8. The non-transitory computer-readable medium that stores instructions executable by one or more processors to perform a method for people sharing common passion or interests to collaborate and experience a Trek together as claimed in claim 1, said instructions for reviewing a finished Trek comprising:
instructions for providing information of finished Trek, wherein said information of finished Trek comprising data, location, and identity of a companion;
instructions for providing a synopsis of said finished Trek;
instructions for rating said companion; and
instructions for providing a reason for said rating.

9. The non-transitory computer-readable medium that stores instructions executable by one or more processors to perform a method for people sharing common passion or interests to collaborate and experience a Trek together as claimed in claim 1, further comprising:
instructions for integrating said method with a service selected from the group consisting of travel service, destination service, arts and entertainment service, sporting events, retailers, discount provider, and any combination of the foregoing, wherein said travel service comprises airline, hotel and car rental service and said destination service comprises resort and lodge.

10. The non-transitory computer-readable medium that stores instructions executable by one or more processors to perform a method for people sharing common passion or interests to collaborate and experience a Trek together as claimed in claim 1, further comprising
instructions for providing a CorkBoard, wherein said CorkBoard is a platform where users connect and collaborate with each other; and
said CorkBoard comprising a plurality of functions of Trekker Matches, a My Treks, Friends, Booking Request, Advertisements Offers and Notifications.

11. The non-transitory computer-readable medium that stores instructions executable by one or more processors to perform a method for people sharing common passion or interests to collaborate and experience a Trek together as claimed in claim 10, further comprising:
instructions for displaying advertisements on said Advertisements Offers;
instructions for customizing said Advertisements Offers; and
instructions for updating said Advertisements Offers.

12. The non-transitory computer-readable medium that stores instructions executable by one or more processors to perform a method for people sharing common passion or interests to collaborate and experience a Trek together as claimed in claim 1, further comprising
instructions for executing said method for people sharing common passion or interests to collaborate and experience a Trek together with an internet website; and
instructions for executing said method for people sharing common passion or interests to collaborate and experience a Trek together with an application (App) running on a handheld device, wherein said handheld device comprises mobile device and tablet computer.

13. The non-transitory computer-readable medium that stores instructions executable by one or more processors to perform a method for people sharing common passion or interests to collaborate and experience a Trek together as claimed in claim 1, further comprising
instructions for integrating said method with a social media network;
instructions for integrating said method with an online dating network;
instructions for serving as a portal for personal networking; and
instructions for serving as a portal for Trek planning.

14. A non-transitory computer-readable medium that stores instructions executable by one or more processors to perform a method for people sharing common passion or interests to collaborate and experience a Trek together, comprising
instructions for establishing an account;
instructions for setting up a calendar;
instructions for executing a search for a Trek, wherein said Trek comprises an activity, event, trip and attraction;
instructions for facilitating communication among users;
instructions for sharing a Trek experience;
instructions for reviewing a finished Trek;
instructions for executing said method for people sharing common passion or interests to collaborate and experience a Trek together with an internet website;
instructions for executing said method for people sharing common passion or interests to collaborate and experience a Trek together with an application (App) running on a handheld device, wherein said handheld device comprises mobile device and tablet computer;
instructions for integrating said method with a social media network;
instructions for integrating said method with an online dating network;
instructions for serving as a portal for personal networking; and
instructions for serving as a portal for Trek planning.

15. The non-transitory computer-readable medium that stores instructions executable by one or more processors to perform a method for people sharing common passion or interests to collaborate and experience a Trek together as claimed in claim 14, said instructions for establishing an account comprising:
instructions for promoting a user to registering;
instructions for receiving personal information, wherein said personal information comprises user name, password, email address and demographic date;
instructions for receiving a personal profile, wherein said personal profile comprises personal interest, travel experience, certification and accomplishment;
instructions for checking if said personal information is valid;
instructions for saving said personal information and said personal profile in a database;
instructions for sending a confirmation email to said user;
instructions for promoting said user to selecting an account type, wherein said account type comprises guest account, Trekker account, Trekker PRO account, Trekker Enterprise account and Trekker Merchant account;
instructions for designating said guest account to an individual who wants to use said method for people sharing common passion or interests to collaborate and experience a Trek together, but does not want to share information;
instructions for designating said Trekker account to an individual who wants to use said method for people sharing common passion or interests to collaborate and wants to share information, but does not want to pay a fee;
instructions for designating said Trekker account to an individual who wants to use said method for people sharing common passion or interests to collaborate, wants to share information, and wants to pay a fee;
instructions for designating said Trekker Enterprise account to a business that does not want to pay a fee; and
instructions for designating said Trekker Merchant account to a business that wants to pay a fee.

16. The non-transitory computer-readable medium that stores instructions executable by one or more processors to perform a method for people sharing common passion or interests to collaborate and experience a Trek together as claimed in claim 14, further comprising:
instructions for displaying a blank calendar;
instructions for clicking on an expected date for a desired Trek;
instructions for providing information of said desired Trek, wherein said information of a desired Trek comprises expected location and expected activity;
instructions for saving said information of said desired Trek in a database;
instructions for selecting a category for a searched Trek;
instructions for selecting a date for said searched Trek;
instructions for selecting a location for said searched Trek;
instructions for processing information for said searched Trek;
instructions for saving said information for said searched Trek in a database;
instructions for searching for said searched Trek; wherein said searching comprises a parameter searching;
instructions for presenting a search result, wherein said search result is a match of said searched Trek or no information found;
instructions for informing a first user who initiates said search for said Trek after a match is found;
instructions for informing a second user who is found as a match of said search;
instructions for executing an anonymous communication between said first user and said second user; and
instructions for facilitating further communication between said first user and said second user.

17. The non-transitory computer-readable medium that stores instructions executable by one or more processors to perform a method for people sharing common passion or interests to collaborate and experience a Trek together as claimed in claim 14, further comprising:
instructions for providing information of said Trek experience, wherein said Trek experience comprises date, location and activity;
instructions for uploading a photo or a plurality of photos in said Trek experience;
instructions for resizing said photo or a plurality of photos being uploaded;
instructions for presenting a preview of said photo or a plurality of photos for approval;
instructions for displaying an approved photo;
instructions for displaying said information of said Trek experience;
instructions for providing information of finished Trek, wherein said information of finished Trek comprises data, location, and identity of a companion;
instructions for providing a synopsis of said finished Trek;
instructions for rating said companion; and
instructions for providing a reason for said rating.

18. The non-transitory computer-readable medium that stores instructions executable by one or more processors to perform a method for people sharing common passion or interests to collaborate and experience a Trek together as claimed in claim 14, further comprising
instructions for providing a CorkBoard, wherein said CorkBoard is a platform where users connect and collaborate with each other; and
said CorkBoard comprising a plurality of functions of Trekker Matches, a My Treks, Friends, Booking Request, Advertisements Offers and Notifications.

19. The non-transitory computer-readable medium that stores instructions executable by one or more processor to perform a method for people sharing common passion or interests to collaborate and experience a Trek together as claimed in claim 18, further comprising:
instructions for integrating said method with a service selected from the group consisting of travel service, destination service, arts and entertainment service, sporting events, retailers, discount provider, and any combination of the foregoing, wherein said travel service comprises airline, hotel and car rental service and said destination service comprises resort and lodge;
instructions for displaying advertisements on said Advertisements Offers;
instructions for customizing said Advertisements Offers; and
instructions for updating said Advertisements Offers.

20. A non-transitory computer-readable medium that stores instructions executable by one or more processors to perform a method for people sharing common passion or interests to collaborate and experience a Trek together, comprising instructions for establishing an account;
instructions for setting up a calendar;
instructions for executing a search for a Trek, wherein said Trek comprises activity, event, trip and attraction;
instructions for facilitating communication among users;
instructions for sharing a Trek experience;
instructions for reviewing a finished Trek;
instructions for executing said method for people sharing common passion or interests to collaborate and experience a Trek together with an internet website;
instructions for executing said method for people sharing common passion or interests to collaborate and experience a Trek together with an application (App) running on a handheld device, wherein said handheld device comprises mobile device and tablet computer;
instructions for integrating said method with a social media network;
instructions for integrating said method with an online dating network;
instructions for serving as a portal for personal networking; and
instructions for serving as a portal for Trek planning.

21. The non-transitory computer-readable medium that stores instructions executable by one or more processors to perform a method for people sharing common passion or interests to collaborate and experience a Trek together as claimed in claim 20, further comprising
instructions for integrating said method with a service selected from the group consisting of travel service, destination service, arts and entertainment service, sporting events, retailers, discount provider, and any combination of the foregoing, wherein said travel service comprises airline, hotel and car rental service and said destination service comprises resort and lodge;
instructions for providing a CorkBoard, wherein said CorkBoard is a platform where users connect and collaborate with each other; and
said CorkBoard comprising a plurality of functions of Trekker Matches, a My Treks, Friends, Booking Request, Advertisements Offers and Notifications.

22. The non-transitory computer-readable medium that stores instructions executable by one or more processors to perform a method for people sharing common passion or interests to collaborate and experience a Trek together as claimed in claim 21, said instructions for establishing an account comprising:
instructions for promoting a user to register;
instructions for receiving personal information, wherein said personal information comprises user name, password, email address and demographic date;
instructions for receiving a personal profile, wherein said personal profile comprises personal interest, travel experience, certification and accomplishment;
instructions for checking if said personal information is valid;
instructions for saving said personal information and said personal profile in a database;
instructions for sending a confirmation email to said user;
instructions for promoting said user to select an account type, wherein said account type comprises guest account, Trekker account, Trekker PRO account, Trekker Enterprise account and Trekker Merchant account;
instructions for designating said guest account to an individual who wants to use said method for people sharing common passion or interests to collaborate and experience a Trek together, but does not want to share information;
instructions for designating said Trekker account to an individual who wants to use said method for people sharing common passion or interests to collaborate and wants to share information, but does not want to pay a fee;
instructions for designating said Trekker account to an individual who wants to use said method for people sharing common passion or interests to collaborate, wants to share information, and wants to pay a fee;
instructions for designating said Trekker Enterprise account to a business who does not want to pay a fee; and
instructions for designating said Trekker Merchant account to a business who wants to pay a fee.

23. The non-transitory computer-readable medium that stores instructions executable by one or more processors to perform a method for people sharing common passion or interests to collaborate and experience a Trek together as claimed in claim 21, further comprising:
instructions for displaying a blank calendar;
instructions for clicking on an expected date for a desired Trek;
instructions for providing information of said desired Trek, wherein said information of a desired Trek comprises expected location and expected activity;
instructions for saving said information of said desired Trek in a database;
instructions for selecting a category for a searched Trek;
instructions for selecting a date for said searched Trek;
instructions for selecting a location for said searched Trek;
instructions for processing information for said searched Trek;
instructions for saving said information for said searched Trek in a database;
instructions for searching for said searched Trek; wherein said searching comprises a parameter searching;
instructions for presenting a search result, wherein said search result is a match of said searched Trek or no information found;
instructions for informing a first user who initiates said search for said Trek after a match is found;
instructions for informing a second user who is found as a match of said search;
instructions for executing an anonymous communication between said first user and said second user;
instructions for facilitating further communication between said first user and said second user;
instructions for providing information of said Trek experience, wherein said Trek experience comprises date, location and activity;
instructions for uploading a photo or a plurality of photos in said Trek experience;
instructions for resizing said photo or a plurality of photos being uploaded;
instructions for presenting a preview of said photo or a plurality of photos for approval;
instructions for displaying an approved photo;
instructions for displaying said information of said Trek experience;
instructions for providing information of finished Trek, wherein said information of finished Trek comprises data, location, and identity of a companion;
instructions for providing a synopsis of said finished Trek;
instructions for rating said companion;
instructions for providing a reason for said rating;
instructions for displaying advertisements on an advertisement board;
instructions for customizing said advertisement board; and
instructions for updating said advertisement board.
